(19) United States
(12) Patent Application Publication
(10) Pub. No.: US 2017/0356329 A1
(43) Pub. Date: Dec. 14, 2017

(54) Bracketing Systems for Ducts and Hoses in a Vehicle's Engine Compartment

(71) Applicant: Ford Global Technologies, LLC, Dearborn, MI (US)

(72) Inventors: Qingrui John Liu, Ann Arbor, MI (US); Tofiqul Islam, Rochester Hills, MI (US); Preet Kamal Virk, Canton, MI (US); James William Ortman, Saline, MI (US); Robert Joseph Mohan, Canton, MI (US)

(21) Appl. No.: 15/180,058

(22) Filed: Jun. 12, 2016

(51) Int. Cl. F01P 11/04; F01P 3/20; F02M 35/02

(52) U.S. Cl. CPC F01P 11/04; F02M 35/0201; F01P 3/20

(57) ABSTRACT

As engines are developing more specific power than earlier versions, the engines move more severely in the engine compartment during torque changes than prior engines. A more robust system to retain engine ducts and tubes is desired, particularly for situations where one end of the duct is mounted to a sub-component in the engine compartment and another end to the engine. A bracketing system for a powerplant for a vehicle has an engine mounted to a vehicle frame via engine mounts, an air cleaner mounted to the vehicle frame, a duct fluidly coupling the air cleaner with the engine, a first bracket coupled to and wrapped around a portion of an engine component, and a second bracket coupled to the first bracket. The first bracket has an orifice for the tie straps to secure the engine coolant tubes and the second bracket is curved to accept the duct.

### FIELD

The present disclosure relates to securing ducts and hoses in the engine compartment of a vehicle.

### BACKGROUND

Modern internal combustion engines have increasing specific power goals to meet customer expectations. These more highly rated engines move with respect to their neutral positions under conditions of rapid changes in torque. Engines are mounted to vehicle frames via engine mounts. If the engine mounts restrict the engine, the accelerations of the engine are communicated through the vehicle frame to occupants. Thus, the engine mounts locate the engine, while allowing some displacement of the engine. Fluids provided to the engine, e.g., engine coolant and air, pass through components that are hard mounted to the vehicle, such as the radiator and the air induction system, respectively. The tubes and ducts transporting these fluids are flexible enough to give slightly to accommodate the relative movement between the engine and the vehicle frame. It is desirable to have a bracketing system that allows such flexibility while keeping the tubes and ducts securely mounted.

In FIG. 1, an engine compartment 10, from the perspective of looking down on a vehicle with the hood removed, shows a rough representation of some of the components under the hood. The opening of engine compartment 10 is affixed to frame components 12. Engine 14 and transmission 16 are mounted to frame 12 via engine mounts 18. The rear-wheel drive type configuration shown in FIG. 1 with the output shaft 20 extending out toward the rear of the vehicle (not shown) has the engine rotating such that displacement of engine 10 with respect to frame 12 is primarily in the direction indicated by two-sided arrow 22. In a more commonly found front-wheel drive configuration, the engine is mounted cross ways in the engine compartment and the movement of engine 14, in response to high torque demand, is perpendicular to arrow 22. Air filter 26 is mounted to engine compartment 10. Air from the atmosphere is inducted through air filter 26 through a duct 28 into engine 14. Radiator 3o is coupled to engine compartment 10 and/or frame 12, in some embodiments. A water pump ₃2 coupled to engine 14 provides pressurized coolant to engine 14. Heated coolant comes out of engine 14 through a duct ₃6 into radiator ₃o and after cooling in radiator ₃0 through a duct 38 provided to pump ₃2. Air filter box 26 and radiator ₃o are affixed to engine compartment 10 and/or frame elements 12. Engine 14 and water pump 32 move together and coupled to frame 12 via engine mounts that allow a certain amount of movement of engine 14 and water pump 32 with respect to frame 12.

### SUMMARY

To overcome at least one problem in the prior art, a retention system for a vehicle includes an engine mounted to a vehicle frame via engine mounts, an air cleaner mounted to the vehicle frame, a duct fluidly coupling the air cleaner with the engine, a first bracket coupled to and wrapped around a portion of an engine component, and a second bracket coupled to the first bracket, the second bracket having a curved portion into which the duct engages.

The first bracket includes a tab extending outwardly from the engine component. The tab has an orifice through which a retention tie strap is laced and then wrapped around a coolant supply hose that is fluidly coupled to the engine. A second retention tie strap is laced through the orifice in the first bracket and wrapped around a coolant return hose.

In some embodiment, the first bracket also includes two tabs that extend in a direction away from the engine component to which the first bracket is coupled. The two tabs are provided on either side of a location on the first bracket where the second bracket is coupled thereto. The tabs prevent the second bracket from rotating.

The second bracket is coupled to the first bracket via a bolt or any suitable coupling system.

An engine retention system for retaining engine ducts includes: an engine cover, an engine bracket coupled to the engine cover wherein the engine bracket wraps around a portion of a periphery of the engine cover, at least two fasteners coupling the engine bracket to the engine cover, a rounded bracket coupled to the engine bracket, and a duct situated in the rounded bracket. The engine bracket has at least one tab with at least one orifice. The tab extends outwardly from the engine component.

The engine retention may further include a coolant duct and a retention tie strap threaded through the at least one orifice. The retention strap encircles the coolant duct. The retention system may further include a second coolant duct and a second retention tie strap threaded through the orifice, the second retention strap encircling the second coolant duct.

The second retention strap encircles the second coolant duct.

In some embodiments, the rounded bracket wraps around a portion of the periphery of the duct.

Also disclosed is a retention system for an engine compartment of a vehicle. The system has an engine mounted to a vehicle's frame via engine mounts. First and second engine components are mounted to the vehicle's frame. First and second ducts fluidly couple the engine with the first and second engine components, respectively. A first bracket is coupled to and wrapped around a portion of a cover affixed to the engine. A second bracket is coupled to the first bracket. The second bracket has a curved portion into which the first duct engages. At least one orifice is defined in an end of the first bracket and a retention tie strap is threaded through the at least one orifice and wrapped around the second duct.

The second bracket engages with the first duct around less than a half of a periphery of the first duct.

In some embodiments, the second bracket is integrally formed with the first bracket.

### BRIEF DESCRIPTION OF THE DRAWINGS

FIG. 1 is a rough illustration of an engine mounted in an engine compartment according to the prior art;

FIG. 2 illustrates a bracketing system according to an embodiment of the disclosure; and

FIG. 3 illustrates the bracketing system of FIG. 2 in the context of an assembly mounted in an engine compartment.

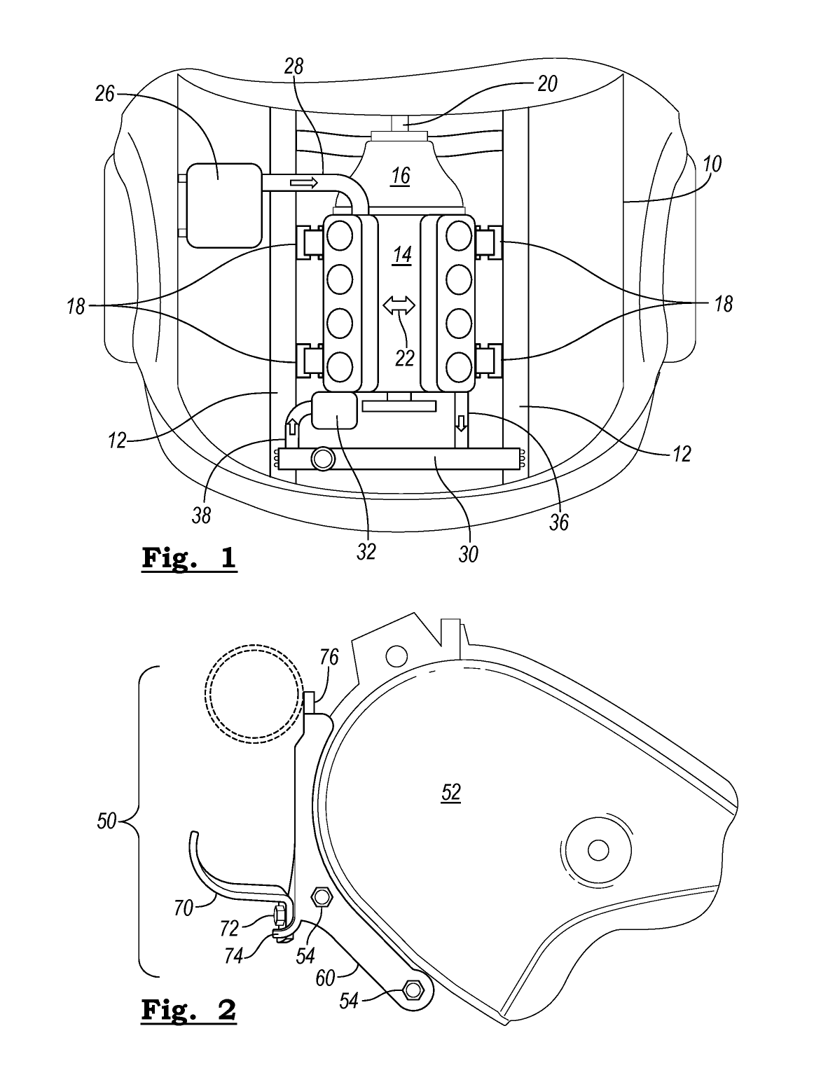

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

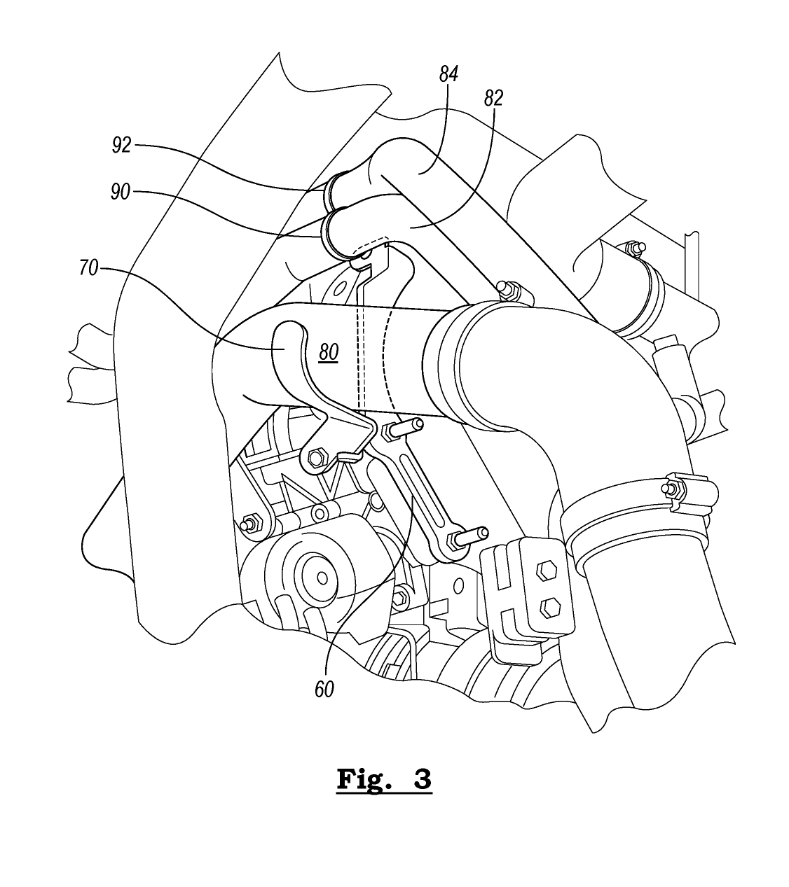

A bracketing system 50 has a first bracket 60 that is coupled to an engine cover 52 via at least two bolts 54. First bracket 60 wraps around a portion of the periphery of engine cover 52. A second bracket 70 couples to the first bracket via a bolt 72. Alternatively, second bracket 70 couples to first bracket 60 by any suitable fastener or coupler, such as rivets, brazing, welding, snap closure, as some non-limiting examples. First bracket 60 has tabs 74 (only one of which is visible in FIG. 2) that are provided to prevent bracket 70 from rotating. Second bracket 70 has at least one orifice through which a retention tie strap (not shown) can be threaded.

In FIG. 3, brackets 60 and 70 are shown installed within an engine compartment. A duct 80 engages with second bracket 70. A first coolant hose 82 is secured to first bracket 60 via a first retention tie strap 90 and a second coolant hose 8₄ is secured to first bracket 60 via a second retention tie strap 92.

In some embodiments, second bracket 70 is thinner than first bracket 60 such that first bracket flexes to allow some movement of duct 80 to make up for the relative movement of the engine to which first and second brackets 60 and 70 are coupled and the engine compartment to which one end of duct 80 is coupled. Similarly, retention straps 90 and 92 are not rigid and allow some movement of coolant hoses 82 and 84.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments described herein that are characterized as less desirable than other embodiments or prior art implementations with respect to one or more characteristics are not outside the scope of the disclosure and may be desirable for particular applications.

We claim:

1. A retention system for a vehicle, comprising:
an engine mounted to a vehicle frame via engine mounts;
an air cleaner mounted to the vehicle frame;
a duct fluidly coupling the air cleaner with the engine;
a first bracket coupled to and wrapped around a portion of an engine component; and
a second bracket coupled to the first bracket, the second bracket having a curved portion into which the duct engages.

2. The retention system of claim 1 wherein the first bracket includes a tab extending outwardly from the engine component, the tab having an orifice defined therein, the retention system further comprising:
a coolant supply hose; and
a retention tie strap laced through the orifice and around the coolant supply hose.

3. The retention system of claim 2, further comprising:
a coolant return hose; and
a retention tie strap laced through the orifice and around the coolant return hose.

4. The retention system of claim 1 wherein the first bracket further comprises two tabs that extend in a direction away from the engine component to which the first bracket is coupled; and the two tabs are provided on either side of a location on the first bracket where the second bracket is coupled thereto.

5. The retention system of claim 1 wherein the second bracket is coupled to the first bracket via a bolt.

6. The retention system of claim 1 wherein the first bracket has internal threads into which the bolt engages.

7. The retention system of claim 1 wherein the first bracket is coupled to the engine component via at least two bolts.

8. An engine retention system for retaining engine ducts, comprising:
an engine cover;
an engine bracket coupled to the engine cover wherein the engine bracket wraps around a portion of a periphery of the engine cover;
at least two fasteners coupling the engine bracket to the engine cover;
a rounded bracket coupled to the engine bracket; and
a duct situated in the rounded bracket wherein:
the engine bracket has at least one tab with at least one orifice defined therein; and
the tab extends outwardly from the engine component.

9. The engine retention system of claim 8, further comprising:
a coolant duct; and
a retention tie strap threaded through the at least one orifice wherein the retention strap encircles the coolant duct.

10. The engine retention system of claim 8, further comprising:
a first coolant duct;
a first retention tie strap threaded through a first of the at least one orifice wherein the first retention strap encircles the first coolant duct;
a second coolant duct;
a second retention tie strap threaded through a second of the at least one orifice wherein the second retention strap encircles the second coolant duct.

11. The engine retention system of claim 8 wherein the duct is an air duct.

12. The engine retention system of claim 8 wherein the rounded bracket is coupled to the engine bracket via a bolt.

13. The engine retention system of claim 8 wherein the rounded bracket wraps around a portion of the periphery of the duct.

14. A retention system for an engine compartment of a vehicle, comprising:
an engine mounted to a vehicle's frame via engine mounts;
a first engine component mounted to the vehicle's frame;
a second engine component mounted to the vehicle's frame;
a first duct fluidly coupling the engine with the first engine component;
a second duct fluidly coupling the engine with the second engine component;
a first bracket coupled to and wrapped around a portion of a cover affixed to the engine;
a second bracket coupled to the first bracket, the second bracket having a curved portion into which the first duct engages;
at least one orifice defined in an end of the first bracket; and
a retention tie strap threaded through the at least one orifice and wrapped around the second duct.

15. The retention system of claim 14 wherein the first engine component is an air cleaner and the first duct is an air duct.

16. The retention system of claim 14 wherein the second engine component is a radiator and the second duct is a coolant duct.

17. The retention system of claim 14 wherein the second bracket engages with the first duct around less than a half of a periphery of the first duct.

18. The retention system of claim 14, further comprising:
a third duct fluidly coupling the engine with the second engine component; and
a second retention tie strap threaded through the at least one orifice and wrapped around the third duct.

19. The retention system of claim 14 wherein the second bracket is integrally formed with the first bracket.
